(19) United States
(12) Patent Application Publication
(10) Pub. No.: US 2002/0138426 A1
(43) Pub. Date: Sep. 26, 2002

(54) Concentration of electronic payments

(75) Inventor: Donald K. Craddick, Westlake Village, CA (US)

Correspondence Address: Steven C. Sereboff, Koppel & Jacobs, Suite 107, 555 St. Charles Drive, Thousand Oaks, CA, 91360, US

(73) Assignee: StreamTrans, Inc., Westlake Village, CA (US)

(21) Appl. No.: 10/020,641

(22) Filed: Dec. 10, 2001

Related U.S. Application Data
(60) Provisional application No. 60/278,406, filed on Mar. 26, 2001.

(51) Int. Cl. G06F 17/60

(52) U.S. Cl. 705/40

(57) ABSTRACT

Systems and methods for concentrating electronic payments are disclosed. The systems are operated analogously to a lockbox arrangement. A biller establishes a relationship with a financial institution, and the financial institution establishes an electronic lockbox account for the biller. The biller provides electronic bill data to the financial institution. The financial institution receives electronic payments for the biller, and matches the payments against the bill data. The financial institution groups the electronic payments and credits a deposit account of the biller for the grouped payments. The description includes the systems and operations of the biller, the financial institution, the payors and others. Exception handling and reporting are also described.

### BACKGROUND OF THE INVENTION

1. Field of the Invention

The present invention relates to electronic bill presentation and payment.

2. Description of Related Art

In offline bill payment and presentation, billers establish relationships with payors in which each biller creates an account associated with each payor. The biller also obtains and records an address of each payor. The biller uses a mail carrier (e.g., the postal service) to deliver its bills to the addresses of record for the payors. The payors thus consolidate all of their bills into a single place—their mail box. The payors use a mail carrier to deliver their payments (e.g., a check) to the billers. The billers use their mail box to consolidate all of their payments into a single place. Mail boxes can handle any format of paper bill and any format of paper payment. Billers generally provide a form with their bills which includes a summary of the bill, and the payors are expected to return these summaries to the biller with their payments. Billers maintain accounts with financial institutions (e.g., banks) in which they deposit payments and from which they draw out money. Payors maintain accounts with financial institutions in which they deposit money and from which they issue payments (e.g., checks).

In offline bill payment and presentation, there is considerable trust in the relationships. The payors trust that the billers will generate accurate bills. The payors also trust that the billers will use their address information, bill history and payment history for proper uses. The billers trust that the payors provide honest address and other information, and that the payors will pay their bills. The billers and payors trust that the mail carriers will deliver their mail promptly and accurately to one another.

Numerous enhancements have been added to basic offline bill presentation and payment as described above. In one enhancement, many financial institutions provide lockbox services to their billers. In practice, a biller instructs its payors to mail their payments to a mail box which is managed on behalf of the biller by the biller's financial institution. The biller periodically provides bill summary data to its financial institution. As mail arrives in the lockbox, automated equipment opens each envelope, removes the bill summary and check, optically reads them, and matches the payment against the bill summary. The payments are accumulated, typically on a daily basis, and the financial institutions credits the biller's account for the total received (instead of each individual payment). The lockbox arrangement is built upon the existing trust relationship between the billers and the financial institutions and works very well.

Other enhancements have involved additional parties. In one such enhancement, billers employ companies known as called bill service providers to use billing data from the billers to generate and mail the paper bills. Many new services for the offline bill presentation and payment have gained the trust of the existing players, and have become successful and integral.

No doubt, offline bill payment and presentation has worked very well for hundreds of years with very little change. It is generally reliable, timely and inexpensive. It is built upon relationships of trust. There are countless trusted parties with which to have relationships, so everyone has considerable flexibility in selecting their business partners and these selections can be changed easily and quickly. Likewise mailing addresses can be changed at any time with little inconvenience. Billers can change their bill formats at any time and it never confuses a payor's mailbox.

However, automation becomes more and more desirable as the number of payors increases for a given biller, and the number of billers increases for a given payor. Each paper bill costs an average of $0.45 to $5.50 to deliver. If payment and remittance costs are included, the average value per bill is $0.88 to $16.21, not including lost float. In many situations, computers and telecommunications networks provide reasonable alternatives to paper bills, paper checks, and the mail. There is a tremendous margin available for delivering bills electronically while providing savings to every participant. Thus, there has long been discussion and efforts in providing electronic bill presentation and payment. Efforts in the field began at least thirty years ago, and major efforts were certainly made at least twenty years ago.

To achieve the desired benefits of electronic bill presentation and payment, numerous new technologies have been developed and numerous new companies have been created to provide enabling services. Many of these efforts have focused on payors—enabling payors to make payments online. Other efforts have focused on providing billers with a means for transmitting their bills electronically. Most of these new entrants into the bill presentment and payment industry have attempted to become consolidators. These new entrants aimed for exclusive relationships between billers and payors which would eliminate or marginalize financial institutions and mail carriers—the two pillars of offline bill presentment and payment.

The original premise of electronic bill presentment and payment was that it would cost far less than printed bills and payments. The prevailing assumption was that electronic bill presentment and payment was going to save so much money that the service could be offered to payers for free and the billers would still save money. Today, we find that typical electronic bill presentment and payment service providers charge fees to the biller and the payer—fees that are far in excess to the paper costs—but still cannot turn a profit. It seems that the only thing which scales with the business of an electronic bill presentment and payment player is its negative profits (i.e., its losses).

One of the problems in current electronic bill presentment and payment is the proliferation of standards. The billing industry is rife with standards: EDI, OFX, XML, IFX, PDF, JPEG, ERP, QIF, CheckFree API, ACH and more. Furthermore, no single standard has the attention of even 4 percent of the biller market. As a result, there has been no ability or desire to exchange bills and payments between billers, payers, consolidators and financial institutions.

As recently as 1998, many people in the financial industry believed that eighty percent or more of all bill presentation and payment in the United States would be handled electronically by 2001. That prediction has fallen incredibly short. For example, of the recurring household bills paid in 1999, 0.0056% of the total were electronically presented and paid. Despite tremendous growth of Internet access, computer penetration and online transactions, little has changed since 1999. After years of work, billions of dollars expended in research, development and marketing, and clear benefits to automation, electronic bill payment and presentation has failed by most measures.

### DESCRIPTION OF THE DRAWINGS

The present invention will be described by way of exemplary embodiments, but not limitations, illustrated in the accompanying drawings in which like references denote similar elements.

FIG. 1 is a block diagram of an online financial environment in accordance with the invention.

FIG. 2 is a data flow diagram of electronic payment concentration in accordance with the invention.

FIG. 3 is a flow chart of a method of concentrating electronic payments in accordance with the invention.

### DETAILED DESCRIPTION OF THE INVENTION

In the following description of the invention, the systems of the invention will be described and then the methods of the invention. In this description, there is a distinction made between parties (e.g., financial institutions, billers, payors) and the systems (e.g., computers) which are controlled and used by those parties.

The Systems of the Invention

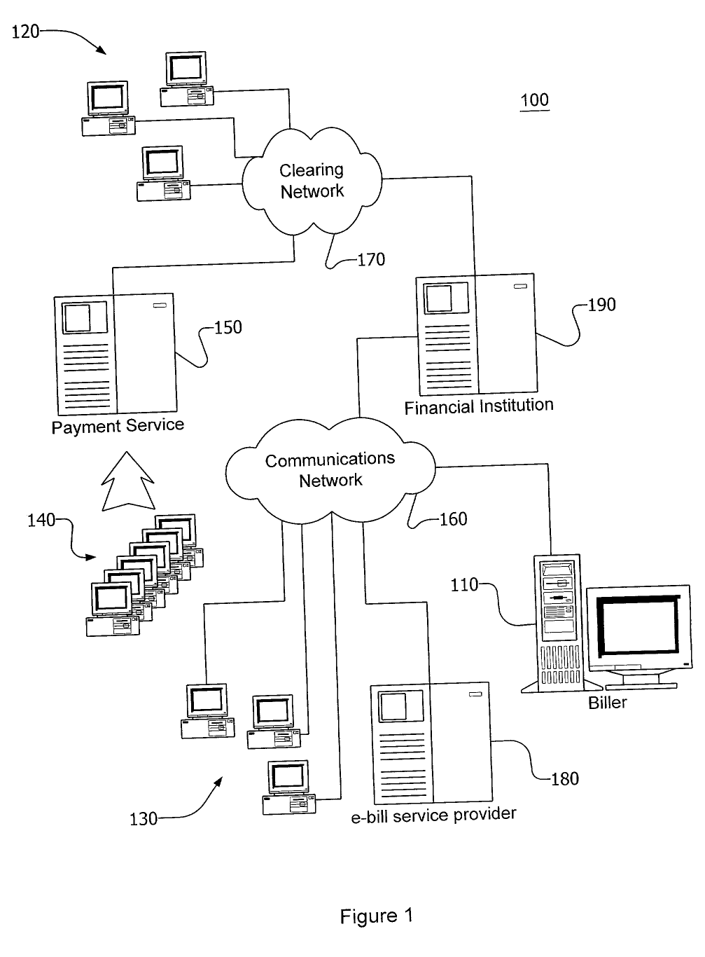

Referring now to FIG. 1, there is shown a block diagram of an online financial environment 100. The online financial environment 100 is useful for concentrating electronic payments in accordance with the invention. The online financial environment 100 includes a financial institution system 190 and a biller system 110. The online financial environment 100 may further include a first group of payor systems 120, a second group of payor systems 130, a third group of payor systems 140, a payment service provider system 150, a communications network 160, a clearing network 170 and an e-bill service provider system 180.

Several types of payors are discussed herein. Payors which make electronic payments via e-mail are referred to herein as “e-type” payors. Payors which make electronic payments via a clearing network are referred to herein as “c-type” payors. Payors which make electronic payments via a payment service provider are referred to herein as “psp-type” payors.

The financial institution system 190 is connected to the clearing network 170 and the communications network 160. The financial institution system 190 comprises a programmed general purpose computer system. In accordance with the invention, the financial institution system 190 may receive electronic payments from c-type payors, e-type payors, psp-type payors and other types of payors. Regardless of the type of payor, the financial institution system 190 may perform lockbox services on their electronic payments. The financial institution may also be a service provider which provides traditional, paper-based lockbox services, but is not itself a bank. By “electronic payment,” it is meant a vehicle to affect the transfer of value. An electronic payment typically is a transfer of funds from one bank depository to another, but may also be a transfer funds to or from a debt instrument, such as a credit card.

The biller system 110 comprises a programmed general purpose computer system. The biller system 110 is used by the biller to generate bill data. The bill data may be used for preparing bills, either by the biller system 110 or by the consolidator system 180, as described below. The biller system 110 may be connected to the communications network 160, and thereby transmit the bill data to the financial institution system 190.

In some cases, for example where the biller is quite large, the biller may act as its own financial institution. For example, the biller may own its own bank, or may have a subsidiary or division which handles traditional, paper-based lockbox services for the biller.

The systems of c-type payors are represented by the first group of payor systems 120. The c-type payor systems 120 are connected to the clearing network 170. The c-type payor systems 120 comprise general purpose computer systems programmed to make electronic payments to the biller via the clearing network 170.

The systems of e-type payors are represented by the second group of payor systems 130. The e-type payor systems 130 are connected to the communications network 160. The e-type payor systems 130 comprise general purpose computer systems programmed to make electronic payments to the biller via e-mail to an e-mail address associated with the biller. An e-mail payment is a credit card, debit card or ACH-backed payment to the biller coupled with an e-mailed notification to the biller. The e-type payors may use payment services such as PayPal, e-count.com, Xign.com. These payment services maintain infrastructure for handling the actual payment, as well as infrastructure for processing e-mail notifications and accounting.

The systems of psp-type payors are represented by the third group of payor systems 140. In contrast to c-type payors and e-type payors, the psp-type payors do not need to be “connected.” Since the payment service provider system 150 makes electronic payments on behalf of the psp-type payors, the psp-type payors need only be able to communicate payment instructions to the payment service provider system 150. As is known in the art, these payment instructions may be electronic, by phone, by mail, or otherwise.

The payment service provider system 150 is connected to the clearing network 170. The payment service provider system 150 comprises a programmed general purpose computer system operated by an payment service provider which make electronic payments for the psp-type payors. Payment service providers may also be aggregators, which aggregate the payments of many payors to the same biller into a payment to the biller. Well-known payment service providers include PayPal, Xign.com, CheckFree Corp., Spectrum, InvoiceLink and Princeton.

The communications network 160 comprises a public electronic data network. The communications network 160 may be or comprise the Internet, for example.

The clearing network 170 comprises a private electronic data network for financial transactions. The clearing network 170 may be or comprise the ACH network, FedWire, SwiftWire, MasterCard RPPS, or other domestic or international payment networks. The communications network 160 and the clearing network 160 may partially overlap, such that the communications network 160 at least partially include the clearing network 170.

The e-bill service provider system 180 is connected to the communications network 160. The e-bill service provider system 180 comprises a programmed general purpose computer system operated by an e-bill service provider. E-bill service providers are a type of service provider which prepare electronic bills for billers and other e-bill service providers and deliver them for presentment to or for payors. Well-known e-bill service providers include CheckFree, Princeton, e-Docs, BillServe, InvoiceLink, Billing Zone and Spectrum. For the purposes of the invention, it is not important whether a biller uses the services of an e-bill service provider. Therefore, there is no further discussion of e-bill service providers. However, it should be appreciated that references to “biller” and “biller system” should be understood to include third parties such as e-bill service providers which act on behalf of the billers and at their instruction, but do not fundamentally alter the relationship between the financial institution and the biller.

The online financial environment of the invention is flexible. It can be used to support many financial institutions, billers, payment service providers and e-bill service providers. Thus, although only one of each is shown, embodiments of the invention may include many financial institution systems, biller systems, payment service provider systems, e-bill service provider systems, communications networks, clearing networks and other service providers.

In a similar vein, the size, spacing and proximity of the various systems shown in FIG. 1 is not intended to show actual size, spacing or proximity.

The Methods of the Invention

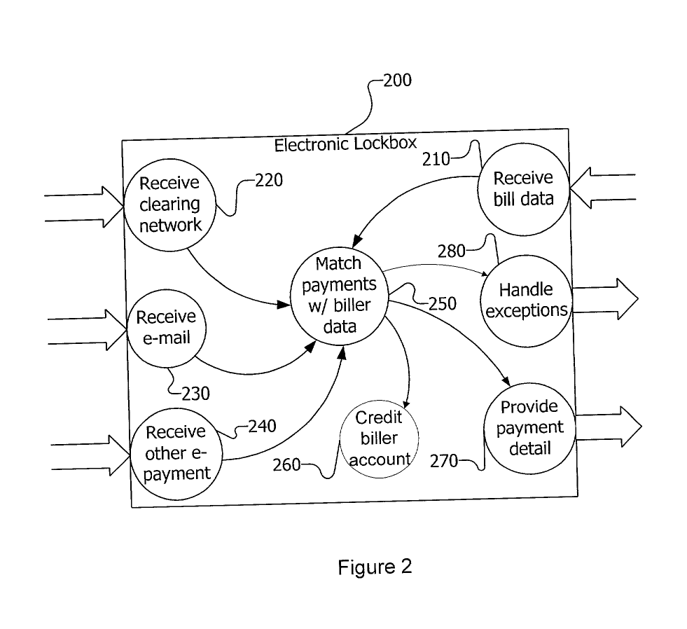

Referring now to FIG. 2, there is shown a data flow diagram of a lockbox 200 for electronic payments in accordance with the invention. The lockbox 200 is provided by a financial institution and is operated within the financial institution system 190. The lockbox 200 includes a number of process which communicate with one another. There are three types of process: input process, internal processes, and output processes. The lockbox 200 may be embodied using well known programming techniques.

The lockbox 200 may include a number of input processes 210, 220, 230, 240. In process 210, the lockbox 200 receives bill data from the biller. The bill data may be provided by the biller system 110 electronically, and may be transmitted directly or indirectly. The bill data may be obtained from many different ways, such as via e-mail, or by fetching it from a web site or FTP site. Standard security protocols, such as HTTPS, may be used. The lockbox 200 may be provided with instructions and intelligence for navigating external computer systems for fetching bill data. Because some bill data may be available only through security means such as user ID/password protection, the biller may provide the needed information to the financial institution system 190. Alternatively, the biller system 110 may be configured to print to the lockbox 200. The lockbox 200 can also receive various forms of electronic payment.

In some situations, the biller may not be in a position to provide bill data to the financial institution. In those cases, the lockbox 200 may operate without bill data while accepting electronic payments as described herein.

In process 220, the lockbox 200 receives electronic payment messages from the clearing network 170. The lockbox 200 may receive these messages from c-type payor systems 120 and from the payment service provider system 150.

In process 230, the lockbox 200 receives electronic payments messages via e-mail from the communications network 160. In bills or other communications to the payors, the payors may be instructed to address e-mail payments to a predefined address or addresses. In accordance with the invention, these predefined e-mail addresses may be within a domain hosted by the financial institution system 190. For example, the e-mail addresses may take the form of <biller>@deposits.<financialinstitution>.com, where <biller> is the biller's name or other identifier, and <financialinstitution> is a second-level domain name of the biller's financial institution (e.g., the biller's bank). The e-mail address may also be within a domain operated by the biller, but which auto-forwards to the lockbox 200.

In process 240, the lockbox 200 receives electronic payments from the communications network 160 in a form other than e-mail. This other form may be instant messages, for example. This other form of electronic payment may be obtained when the financial institution system 190 obtains payment data from a pre-defined web site or FTP site, for example.

The bill data comprises, for each bill, at least an amount due and an identifier. The bill data may take many possible forms. For example, the bill data may be a complete data set of information which the biller produces for generating bills, and which may be combined with bill templates to produce bills. The bill data may be the bills themselves in electronic form. The bill data may be a specially prepared file. The financial institution system 190 may use a map of the bill data to extract the amount due, identifier, and other desired information. This may be particularly beneficial when the financial institution is provided with bill files from the biller “as is.”

The electronic payments received in the lockbox 200 may take a number of forms. The electronic payments of the c-type payor systems 120, the e-type payor systems 130 and the payment service provider system 150 each comprise a payment amount and an identifier. The identifiers may comprise account numbers for the respective payors, bill numbers, the payor's name, the payor's e-mail address, or other number or code which will allow the lockbox 200 to match the electronic payment against a bill from the biller. Through differing formats and protocols, the lockbox 200 can automatically detect which payment service provider or service the payor has used. The financial institution system 190 may perform specific authentications on the electronic payments depending on the relevant transport, format and service provider.

The lockbox 200 may include one or more internal processes, including processes 250 and 260. In the process 250, the lockbox 200 matches the electronic payments against the bill data. The matching process 250 may include validation of the corresponding payor, for example using information found on a most recent bill. The biller may also specify criteria for matching each electronic payment with a particular account and/or bill. Additional validation criteria may include account number, payor name, date, invoice number, payment amount, payment type used most recently by the payor, and others. Matching may be on a sliding scale, with a percentage match or other formula being used. The matching process 250 may be operated on a batch basis, and the batch may consist of one electronic payment or a number of electronic payments. The process 250 may operate according to a predefined schedule, such as once per day, and may operate according to a predefined formula, such as when a predefined number of electronic payments have been received. Matching may be performed on a multi-pass basis, with electronic payments being considered in a second pass if they were not match acceptably in a first match. Particular benefits may be obtained by the financial institution system 190 maintaining records for each payor which include how they have made their payments. This record-keeping may be used to improve matching of later electronic payments.

In the process 260, the lockbox 200 credits the biller's deposit account with the financial institution for the total amount of electronic payments. The timing of the process 260 may be in conjunction with the timing of the matching process 250, or according to schedules as described above. The lockbox 200 may separately group the electronic payments from each type of payor. These separately grouped electronic payments may be matched, credited and reported separately.

The lockbox 200 may include one or more output processes. Output processes 270, 280 may operate in the same manner as corresponding processes in traditional lockbox processing (i.e., where paper checks and bill stubs are matched against bill data).

In process 270, the lockbox 200 provides receipt reports to the biller. The receipt reports may include payment detail reports and summary reports. Reports may be organized by payment service provider and by payor, for example.

In process 280, the lockbox 200 handles exceptions. Exceptions are payments which do not match the bill data. An exception may arise if the payor is unrecognized, if the identifier provided with the electronic payment is unrecognized, if the payment amount is unexpectedly high or low, or for other reasons. Exceptional payments may be accepted, rejected, conditionally accepted or conditionally rejected. In general, the biller will determine how exceptions should be handled. The financial institution system 190 may send a notice to the payors corresponding to exceptions, or return their electronic payments. It may be desirable to have the financial institution system 190 accept exceptional electronic payments, but issue a notice to the relevant payors that there was an exception. Exception handling may include generating an exception report for the biller. The financial institution system 190 or individuals employed by the financial institution may undertake some exception processing through automated and/or manual means.

The timing of the processes 270, 280 may be in conjunction with the timing of the matching process 250, in real-time, in real-enough time, or according to schedules as described above. The financial institution system 190 may use output maps to format the payment detail reports and exception reports to accommodate the biller's desires and requirements. The payment detail report may be produced in electronic form, such as BAI 2, or paper form. The payment detail reports and the exception reports may be provided to the biller system 110 electronically, and may be transmitted directly or indirectly. The payment detail reports and exception reports may be provided to the biller system 110 in many different ways, such as via e-mail, or by fetching it from a web site or FTP site. The biller may also choose to not receive receipt reports and/or exception reports. The receipt reports and exception reports from the lockbox 200 may be combined with reports of lockbox service provided by the financial institution on paper payments.

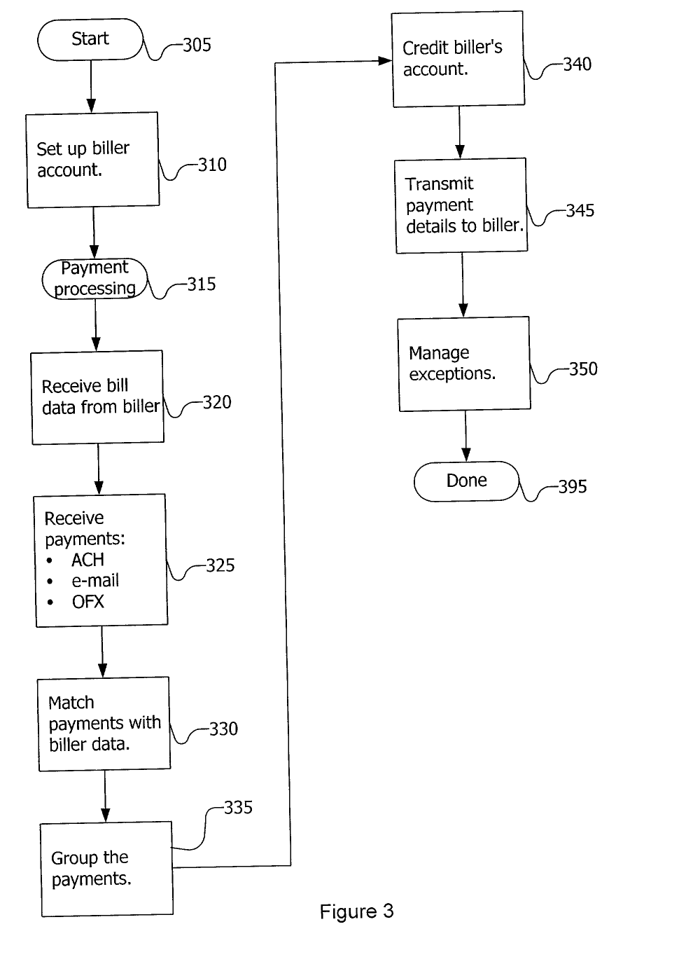

Referring now to FIG. 3, there is shown a flow chart of a method of operating the lockbox 200 for electronic payments in accordance with the invention. After the method begins (step 305), the biller and financial institution set up a deposit account for the biller with the financial institution (step 310). The deposit account may be a savings account, checking account, or other form of depository account which can be credited for the electronic payments received by the lockbox 200. If the financial institution also provides the biller with lockbox services for paper payments, then a single deposit account may be used for both the paper payment lockbox services and the electronic payment lockbox services. The deposit account need only be set up once, and thereafter the lockbox 200 may operate generally as described above with respect to FIG. 2.

The payment processing portion of the method begins at step 315. Analogous to processes 210, 220, 230 and 240, the bill data and the electronic payments are received by the financial institution system 190 (steps 320, 325, respectively). Next, the lockbox 200 matches the electronic payments with the bill data (step 330). After grouping the matched electronic payments (step 335), the biller's deposit account may be credited for the total of the electronic payments in the group (step 340). Next, the financial institution system 190 generates a report of the matched electronic payments and the credits and transmits the report to the biller (step 345). The unmatched electronic payments may then be handled as exceptions (step 350). The method may operate as a generally continuous loop from step 315, and may end upon predefined conditions (step 395).

Conclusion

The invention can provide numerous benefits, including:

financial institutions that offer remittance-processing services for paper based invoices and payments can retain their deposit and payments business;

lower cost;

greater predictability;

increased funds availability;

tighter customer relationships.

Further benefits may include:

allowing anyone to receive a payment from anyone, regardless of whether or not they are a member of an e-payment service; and

giving banks, billers and payors new technology that works with all legacy ERP, accounting and billing systems without modification.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications and alterations should therefore be seen as within the scope of the present invention.

It is claimed:

1. A system for concentrating electronic payments comprising
a clearing network comprising a private electronic data network for financial transactions
a communications network comprising a public electronic data network
a biller system comprising a general purpose computer system programmed to generate bill data, wherein the bill data comprises for each bill an amount due and an identifier
c-type payor systems comprising a first plurality of payor systems connected to the clearing network, the c-type payor systems comprising general purpose computer systems programmed to make individual electronic payments to the biller via the clearing network, the electronic payments of the c-type payor systems comprising a payment amount and an identifier
e-type payor systems comprising a second plurality of payor systems connected to the communications network, the e-type payor systems comprising general purpose computer systems programmed to make individual electronic payments to the biller via e-mail to an e-mail address associated with the biller, the electronic payments of the e-type payor systems comprising a payment amount and an identifier
a financial institution system connected to the clearing network and the communications network, the financial institution system comprising a general purpose computer system programmed to
provide a depository account for the biller
receive the bill data
receive the electronic payments from c-type payor systems
receive the electronic payments from the e-type payor systems
periodically group the electronic payments
match the grouped electronic payments with the bill data using the amount due and the identifier in the bill data on the one hand, and the payment amount and the identifier from the c-type payor systems and the e-type payor systems on the other hand
periodically credit the biller's depository account for the electronic payments from the c-type payor systems and the e-type payor systems.

2. The system for concentrating electronic payments of claim 1 wherein the identifiers in the bill data, the c-type payor system payments and the e-type payor system payments comprise bill numbers.

3. The system for concentrating electronic payments of claim 1 wherein the identifiers in the bill data, the c-type payor system payments and the e-type payor system payments comprise account numbers for the respective payors.

4. The system for concentrating electronic payments of claim 1 wherein the financial institution system is programmed to group the electronic payments from the c-type payor systems separately from the electronic payments from the e-type payor systems.

5. The system for concentrating electronic payments of claim 4 wherein the financial institution system is programmed to, in a first process, match the grouped electronic payments from the e-type payor systems with the bill data, and in a second process, match the grouped electronic payments from the c-type payor systems with the bill data.

6. The system for concentrating electronic payments of claim 1 further comprising an payment service provider system for making payments on behalf of psp-type payors, the psp-type payors comprising a third plurality of payors.

7. The system for concentrating electronic payments of claim 6 wherein the payment service provider system is connected to the clearing network, and the payment service provider system comprises a general purpose computer system programmed to
receive payment authorizations from the psp-type payors
make electronic payments to the biller via the clearing network of aggregated payments for the psp-type payors, the aggregated electronic payments of the payment service provider system comprising a payment amount and an identifier for each individual payment of the psp-type payors.

8. The system for concentrating electronic payments of claim 1 wherein the financial institution system is programmed to credit the biller's depository account for the payments from the c-type payor systems and the e-type payor systems on a daily basis.

9. The system for concentrating electronic payments of claim 1 wherein the financial institution system is programmed to
periodically generate a receipts report of the matched electronic payments
periodically transmit the receipts report to the biller system.

10. The system for concentrating electronic payments of claim 9 wherein the financial institution system is programmed to transmit the receipts report to the biller system on a daily basis.

11. The system for concentrating electronic payments of claim 1 wherein the financial institution system is programmed to generate an exception report of electronic payments from the e-type payor systems which do not match with the bill data.

12. The system for concentrating electronic payments of claim 11 wherein the financial institution system is programmed to transmit the exception report to the biller system.

13. The system for concentrating electronic payments of claim 1 wherein the financial institution system is programmed to generate an exception report of all payments which do not match with the bill data.

14. The system for concentrating electronic payments of claim 1 wherein the financial institution system is programmed to generate an exception report of payments from the c-type payor systems and the e-type payor systems which do not match with the bill data.

15. The system for concentrating electronic payments of claim 14 wherein the financial institution system is programmed to transmit the exception report to the biller system.

16. The system for concentrating electronic payments of claim 1 wherein the clearing network comprises the ACH network.

17. The system for concentrating electronic payments of claim 1 wherein the communications network comprises the Internet.

18. The system for concentrating electronic payments of claim 1 wherein the biller system is connected to the communications network, the biller system is programmed to transmit the bill data to the financial institution system via the communications network.

19. The system for concentrating electronic payments of claim 1 wherein the communications network at least partially includes the clearing network.

20. A method of concentrating electronic payments in a financial institution system, the financial institution system comprising a general purpose computer connected to a clearing network and a communications network, the clearing network comprising a private electronic data network for financial transactions, the communications network comprising a public electronic data network, the method comprising
providing a depository account for a biller
receiving the bill data, the bill data comprising for each bill an amount due and an identifier
receiving individual electronic payments from “c-type” payor systems via the clearing network, the electronic payments from the c-type payor systems each comprising a payment amount and an identifier
receiving individual electronic payments from “e-type” payor systems via the communications network, the electronic payments from the e-type payor systems each comprising a payment amount and an identifier
periodically grouping the electronic payments
matching the grouped electronic payments with the bill data using the amount due and the identifier in the bill data on the one hand, and the payment amount and the identifier from the c-type payor systems and the e-type payor systems on the other hand
periodically crediting the biller's depository account for the electronic payments from the c-type payor systems and the e-type payor systems.

21. The method of concentrating electronic payments in a financial institution system of claim 20 wherein in the step of receiving electronic payments from e-type payor systems, the e-mail address is within a domain hosted by the financial institution system.

22. The method of concentrating electronic payments in a financial institution system of claim 20 wherein the identifiers in the bill data, the c-type payor system payments and the e-type payor system payments comprise bill numbers.

23. The method of concentrating electronic payments in a financial institution system of claim 20 wherein the identifiers in the bill data, the c-type payor system payments and the e-type payor system payments comprise account numbers for the respective payors.

24. The method of concentrating electronic payments in a financial institution system of claim 20 further comprising grouping the electronic payments from the c-type payor systems separately from the electronic payments from the e-type payor systems.

25. The method of concentrating electronic payments in a financial institution system of claim 24 further comprising separately matching the grouped electronic payments from the e-type payor systems with the bill data, and matching the grouped payments from the c-type payor systems with the bill data.

26. The method of concentrating electronic payments in a financial institution system of claim 20 further comprising receiving electronic payments comprising aggregated payments from an payment service provider system on behalf of psp-type payors.

27. The method of concentrating electronic payments in a financial institution system of claim 26 where in the electronic payments from the payment service provider system is received via the clearing network.

28. The method of concentrating electronic payments in a financial institution system of claim 20 further comprising crediting the biller's depository account for the payments from the c-type payor systems and the e-type payor systems on a daily basis.

29. The method of concentrating electronic payments in a financial institution system of claim 20 further comprising
periodically generating a receipts report of the matched electronic payments
periodically transmitting the receipts report to the biller system.

30. The method of concentrating electronic payments in a financial institution system of claim 29 further comprising transmitting the receipts report to the biller system on a daily basis.

31. The method of concentrating electronic payments in a financial institution system of claim 20 further comprising generating an exception report of electronic payments from the e-type payor systems which do not match with the bill data.

32. The method of concentrating electronic payments in a financial institution system of claim 31 further comprising transmitting the exception report to the biller system.

33. The method of concentrating electronic payments in a financial institution system of claim 20 further comprising generating an exception report of all payments which do not match with the bill data.

34. The method of concentrating electronic payments in a financial institution system of claim 20 further comprising generating an exception report of payments from the c-type payor systems and the e-type payor systems which do not match with the bill data.

35. The method of concentrating electronic payments in a financial institution system of claim 34 further comprising transmitting the exception report to the biller system.

36. The method of concentrating electronic payments in a financial institution system of claim 20 wherein the clearing network comprises the ACH network.

37. The method of concentrating electronic payments in a financial institution system of claim 20 wherein the communications network comprises the Internet.

38. The method of concentrating electronic payments in a financial institution system of claim 20 wherein the biller system is connected to the communications network, further comprising receiving the bill data from the biller system via the communications network.

39. The method of concentrating electronic payments in a financial institution system of claim 20 wherein the communications network at least partially includes the clearing network.

40. A financial institution system for concentrating electronic payments, the financial institution system having connections to a clearing network and a communications network, the clearing network comprising a private electronic data network for financial transactions, the communications network comprising a public electronic data network, the financial institution system comprising
means for providing a depository account for a biller
means for receiving the bill data, the bill data comprising for each bill an amount due and an identifier
means for receiving individual electronic payments from “c-type” payor systems via the clearing network, the electronic payments from the c-type payor systems each comprising a payment amount and an identifier
means for receiving individual electronic payments from “e-type” payor systems via the communications network, the electronic payments from the e-type payor systems each comprising a payment amount and an identifier
means for periodically grouping the electronic payments
means for matching the grouped electronic payments with the bill data using the amount due and the identifier in the bill data on the one hand, and the payment amount and the identifier from the c-type payor systems and the e-type payor systems on the other hand
means for periodically crediting the biller's depository account for the electronic payments from the c-type payor systems and the e-type payor systems.

41. The financial institution system for concentrating electronic payments of claim 40 wherein the identifiers in the bill data, the c-type payor system payments and the e-type payor system payments comprise bill numbers.

42. The financial institution system for concentrating electronic payments of claim 40 wherein the identifiers in the bill data, the c-type payor system payments and the e-type payor system payments comprise account numbers for the respective payors.

43. The financial institution system for concentrating electronic payments of claim 40 further comprising means for grouping the electronic payments from the c-type payor systems separately from the electronic payments from the e-type payor systems.

44. The financial institution system for concentrating electronic payments of claim 43 further comprising means for separately matching the grouped electronic payments from the e-type payor systems with the bill data, and matching the grouped payments from the c-type payor systems with the bill data.

45. The financial institution system for concentrating electronic payments of claim 40 further comprising means for receiving electronic payments from an payment service provider system comprising aggregated payments on behalf of psp-type payors.

46. The financial institution system for concentrating electronic payments of claim 45 wherein the means for receiving electronic payments from the payment service provider system is adapted to receive the electronic payments via the clearing network.

47. The financial institution system for concentrating electronic payments of claim 40 further comprising means for crediting the biller's depository account for the payments from the c-type payor systems and the e-type payor systems on a daily basis.

48. The financial institution system for concentrating electronic payments of claim 40 further comprising
means for periodically generating a receipts report of the matched electronic payments
means for periodically transmitting the receipts report to the biller.

49. The financial institution system for concentrating electronic payments of claim 48 further comprising means for transmitting the receipts report to the biller system on a daily basis.

50. The financial institution system for concentrating electronic payments of claim 40 further comprising means for generating an exception report of electronic payments from the e-type payor systems which do not match with the bill data.

51. The financial institution system for concentrating electronic payments of claim 50 further comprising means for transmitting the exception report to the biller system.

52. The financial institution system for concentrating electronic payments of claim 40 further comprising means for generating an exception report of all payments which do not match with the bill data.

53. The financial institution system for concentrating electronic payments of claim 40 further comprising means for generating an exception report of payments from the c-type payor systems and the e-type payor systems which do not match with the bill data.

54. The financial institution system for concentrating electronic payments of claim 53 further comprising means for transmitting the exception report to the biller system.

55. The financial institution system for concentrating electronic payments of claim 40 wherein the clearing network comprises the ACH network.

56. The financial institution system for concentrating electronic payments of claim 40 wherein the communications network comprises the Internet.

57. The financial institution system for concentrating electronic payments of claim 40 wherein the biller system is connected to the communications network, further comprising means for receiving the bill data from the biller system via the communications network.

58. The financial institution system for concentrating electronic payments of claim 40 wherein the communications network at least partially includes the clearing network.

59. A financial institution system for concentrating electronic payments, the financial institution system comprising a general purpose computer system having connections to a clearing network and a communications network, the clearing network comprising a private electronic data network for financial transactions, the communications network comprising a public electronic data network, the financial institution system being programmed to
provide a depository account for a biller
receive the bill data, the bill data comprising for each bill an amount due and an identifier
receive individual electronic payments from “c-type” payor systems via the clearing network, the electronic payments from the c-type payor systems each comprising a payment amount and an identifier
receive individual electronic payments from “e-type” payor systems via the communications network, the electronic payments from the e-type payor systems each comprising a payment amount and an identifier
periodically group the electronic payments
match the grouped electronic payments with the bill data using the amount due and the identifier in the bill data on the one hand, and the payment amount and the identifier from the c-type payor systems and the e-type payor systems on the other hand
periodically credit the biller's depository account for the electronic payments from the c-type payor systems and the e-type payor systems.

60. The financial institution system for concentrating electronic payments of claim 59 wherein the identifiers in the bill data, the c-type payor system payments and the e-type payor system payments comprise bill numbers.

61. The financial institution system for concentrating electronic payments of claim 59 wherein the identifiers in the bill data, the c-type payor system payments and the e-type payor system payments comprise account numbers for the respective payors.

62. The financial institution system for concentrating electronic payments of claim 59 wherein the financial institution system is programmed to group the electronic payments from the c-type payor systems separately from the electronic payments from the e-type payor systems.

63. The financial institution system for concentrating electronic payments of claim 62 wherein the financial institution system is programmed to, in a first process, match the grouped electronic payments from the e-type payor systems with the bill data, and in a second process, match the grouped electronic payments from the c-type payor systems with the bill data.

64. The financial institution system for concentrating electronic payments of claim 59 wherein the financial institution system is programmed to receive electronic payments comprising aggregated payments from an payment service provider system on behalf of psp-type payors.

65. The financial institution system for concentrating electronic payments of claim 64 wherein the financial institution system is programmed to receive the aggregated payments via the clearing network.

66. The financial institution system for concentrating electronic payments of claim 59 wherein the financial institution system is programmed to credit the biller's depository account for the payments from the c-type payor systems and the e-type payor systems on a daily basis.

67. The financial institution system for concentrating electronic payments of claim 59 wherein the financial institution system is programmed to
periodically generate a receipts report of the matched electronic payments
periodically transmit the receipts report to the biller.

68. The financial institution system for concentrating electronic payments of claim 67 wherein the financial institution system is programmed to transmit the receipts report to the biller system on a daily basis.

69. The financial institution system for concentrating electronic payments of claim 59 wherein the financial institution system is programmed to generate an exception report of electronic payments from the e-type payor systems which do not match with the bill data.

70. The financial institution system for concentrating electronic payments of claim 69 wherein the financial institution system is programmed to transmit the exception report to the biller system.

71. The financial institution system for concentrating electronic payments of claim 59 wherein the financial institution system is programmed to generate an exception report of all payments which do not match with the bill data.

72. The financial institution system for concentrating electronic payments of claim 59 wherein the financial institution system is programmed to generate an exception report of payments from the c-type payor systems and the e-type payor systems which do not match with the bill data.

73. The financial institution system for concentrating electronic payments of claim 72 wherein the financial institution system is programmed to transmit the exception report to the biller system.

74. The financial institution system for concentrating electronic payments of claim 59 wherein the clearing network comprises the ACH network.

75. The financial institution system for concentrating electronic payments of claim 59 wherein the communications network comprises the Internet.

76. The financial institution system for concentrating electronic payments of claim 59 wherein the biller system is connected to the communications network, and the financial institution system is further programmed to receive the bill data from the biller system via the communications network.

77. The financial institution system for concentrating electronic payments of claim 59 wherein the communications network at least partially includes the clearing network.
